(19) United States
(12) Patent Application Publication
(10) Pub. No.: US 2023/0118389 A1
(43) Pub. Date: Apr. 20, 2023

(54) Rigid High-Gloss Wear-Resistant and Scratch-Resistant Flooring

(71) Applicant: ANHUI COORDINATED LIN PLASTIC TECHNOLOGY Co., Ltd., Hefei (CN)

(72) Inventor: Chao Lin, Hefei (CN)

(21) Appl. No.: 17/967,997

(22) Filed: Oct. 18, 2022

(30) Foreign Application Priority Data
Oct. 19, 2021 (CN) 202111215105.5

(51) Int. Cl. E04F 15/10; B32B 27/30; B32B 27/20; B32B 27/22; B32B 7/12; B29B 7/90; B29C 43/00; B29C 43/24; B29C 48/00; B29C 48/07

(52) U.S. Cl. CPC E04F 15/107; E04F 15/105; B32B 27/304; B32B 27/20; B32B 27/22; B32B 7/12; B29B 7/90; B29C 43/003; B29C 43/24; B29C 48/0011; B29C 48/07; B29C 48/022; B32B 2264/104; B32B 2307/402; B32B 2307/406; B32B 2307/554; B32B 2307/584; B32B 2419/04; B29K 2027/06

(57) ABSTRACT

The present disclosure provides a rigid high-gloss wear-resistant and scratch-resistant flooring. The flooring includes a surface layer, an intermediate Spc layer, and a decorative layer that are laminated; where the surface layer is prepared by combining a melamine glue and a color film; the intermediate Spc layer is prepared by mixing polyvinyl chloride resin, calcium carbonate, a plasticizer, and a stabilizer; and the decorative layer is prepared by a high-temperature material. The rigid high-gloss wear-resistant and scratch-resistant flooring is prepared by the melamine glue and the special color film, has an intermediate Spc layer, and has the decorative layer on a back side. The flooring is prepared by three different layers through a high temperature and a high pressure. The flooring has a surface that is highly wear-resistant, extremely scratch-resistant, cigarette burning-resistant, and non-deformable, and is suitable for use in various public places, with various styles, diverse specifications, and stability.

### CROSS REFERENCE TO RELATED APPLICATION

This patent application claims the benefit and priority of Chinese Patent Application No. 202111215105.5, filed with the China National Intellectual Property Administration on Oct. 19, 2021, the disclosure of which is incorporated by reference herein in its entirety as part of the present application.

### TECHNICAL FIELD

The present disclosure relates to the technical field of flooring, in particular to a rigid high-gloss wear-resistant and scratch-resistant flooring.

### BACKGROUND

The flooring is a surface layer of the ground or a building surface, and is generally prepared by wooden materials or other materials. According to different classification criteria, the flooring is divided into solid wood flooring, laminate flooring, three-layer solid wood flooring, bamboo flooring, anti-corrosion flooring, cork flooring, and the most popular multi-layer solid wood composite flooring according to structures; alternatively, the flooring is divided into household flooring, commercial flooring, anti-static flooring, outdoor flooring, special flooring for stages, special flooring for gymnasiums, and special flooring for track and field according to uses; alternatively, the flooring is divided into E0 flooring, E1 flooring, F4 flooring, and JAS-standard F4 flooring according to environmental protection levels.

The flooring laid in some public places is generally scratched, while cigarette butts may also cause burns to the flooring. Therefore, the present disclosure is proposed herein.

### SUMMARY

In view of the above deficiencies in the prior art, the present disclosure provides a rigid high-gloss wear-resistant and scratch-resistant flooring.

The present disclosure provides a rigid high-gloss wear-resistant and scratch-resistant flooring, including a surface layer, an intermediate Spc layer, and a decorative layer that are laminated; where

the surface layer is prepared by combining a melamine glue and a color film;

the intermediate Spc layer is prepared by mixing polyvinyl chloride (PVC) resin, calcium carbonate, a plasticizer, and a stabilizer; and

the decorative layer is prepared by a high-temperature material.

Preferably, a preparation method of the intermediate Spc layer includes the following steps: conducting homogenization on the PVC resin, the calcium carbonate, the plasticizer, and the stabilizer by mixing with a high-speed mixer; conducting radial mixing and partially-axial mixing in a cold mixer under the action of a slowly rotating stirring paddle, to reduce a temperature of an obtained mixed powder; discharging the mixed powder from a discharge port of a mold by a twin-screw extruder when the mixed powder is cooled to not greater than 45° C., and calendering, cooling, and shaping.

Preferably, the PVC resin, the calcium carbonate, the plasticizer, and the stabilizer are mixed by the mixer at 80° C. to 90° C. for 10 min, and then at 100° C. to 120° C. for 15 min, and then at greater than 120° C. for 5 min.

Preferably, the decorative layer is formed by pressing into a large sheet by a hot press under a high temperature and a high pressure, and then cutting.

Compared with the prior art, the present disclosure has the following beneficial effects:

The rigid high-gloss wear-resistant and scratch-resistant flooring is prepared by the melamine glue and the special color film, has an intermediate Spc layer, and has the decorative layer on a back side. The flooring is prepared by three different layers through a high temperature and a high pressure. The flooring has a surface that is highly wear-resistant, extremely scratch-resistant, cigarette burning-resistant, and non-deformable, and is suitable for use in various public places, with various styles, diverse specifications, and stability.

### DETAILED DESCRIPTION OF THE EMBODIMENTS

In order to make the objectives, technical solutions and advantages of the examples of the present disclosure more apparent, the technical solution of the examples of the present disclosure will be described clearly and completely below. In order to keep the following description of the examples of the present disclosure clear and concise, the present disclosure omits detailed descriptions of well-known functions and well-known components so as not to unnecessarily obscure the concept of the present disclosure.

A rigid high-gloss wear-resistant and scratch-resistant flooring included a surface layer, an intermediate Spc layer, and a decorative layer that were laminated; where

the surface layer is prepared by combining a melamine glue and a color film;

A preparation method of the intermediate Spc layer included the following steps: homogenization was conducted on PVC resin, calcium carbonate, a plasticizer, and a stabilizer by mixing with a high-speed mixer at 80° C. to 90° C. for 10 min, and then at 100° C. to 120° C. for 15 min, and then at greater than 120° C. for 5 min; radial mixing and partially-axial mixing were conducted in a cold mixer under the action of a slowly rotating stirring paddle, to reduce a temperature of an obtained mixed powder; and the mixed powder was discharged from a discharge port of a mold by a twin-screw extruder when the mixed powder was cooled to not greater than 45° C., and calendering, cooling, and shaping were conducted.

The decorative layer was prepared by a high-temperature material, and then formed by pressing into a large sheet by a hot press under a high temperature and a high pressure, and then cutting.

As was seen in Table 1:

| | Standard requirement | | | | |
|---|---|---|---|---|---|
| Testing requirement | Standard value | Tolerance (mm) | Test results | Unit | Result determination |
| Effective area length (mm) | 1220 | ±0.5 | 1220 | mm | Qualified |
| Effective area width (mm) | 180 | ±0.1 | 180 | mm | Qualified |
| Thickness (mm) | 4.0 | ±0.15 | 4.05 | mm | Qualified |
| Squareness (mm) | 0 | ≤0.20 | 0 | mm | Qualified |
| Straightness (mm) | 0 | ≤0.20 | 0.00 | mm | Qualified |

As was seen in Table 2:

| Performance | Unit | Value |
|---|---|---|
| Ball-pressure strength | N/mm² | ≥60 |
| Tensile intensity | MPa | ≥40 |
| Impact resistance | KJ/m² | ≥8.2 |
| Coefficient of friction | 180 min/7.5 mm | ≤0.03 |

As was seen from Tables 1 and 2, the flooring had a surface that was highly wear-resistant, extremely scratch-resistant, cigarette burning-resistant, and non-deformable.

The above examples are only exemplary in the present disclosure, and not intended to limit the present disclosure, and the protection scope of the present disclosure is defined by the claims. A person skilled in the art can make various modifications or equivalents to the present disclosure within the spirit and scope of the present disclosure. All these modifications or equivalents shall be considered to fall within the protection scope of the technical solutions of the present disclosure.

What is claimed is:

1. A rigid high-gloss wear-resistant and scratch-resistant flooring, comprising a surface layer, an intermediate Spc layer, and a decorative layer that are laminated; wherein
the surface layer is prepared by combining a melamine glue and a color film;
the intermediate Spc layer is prepared by mixing polyvinyl chloride (PVC) resin, calcium carbonate, a plasticizer, and a stabilizer; and
the decorative layer is prepared by a high-temperature material.

2. The rigid high-gloss wear-resistant and scratch-resistant flooring according to claim 1, wherein a preparation method of the intermediate Spc layer comprises the following steps:
conducting homogenization on the PVC resin, the calcium carbonate, the plasticizer, and the stabilizer by mixing with a high-speed mixer; conducting radial mixing and partially-axial mixing in a cold mixer under the action of a slowly rotating stirring paddle, to reduce a temperature of an obtained mixed powder; discharging the mixed powder from a discharge port of a mold by a twin-screw extruder when the mixed powder is cooled to not greater than 45° C., and conducting calendering, cooling, and shaping.

3. The rigid high-gloss wear-resistant and scratch-resistant flooring according to claim 2, wherein the PVC resin, the calcium carbonate, the plasticizer, and the stabilizer are mixed by the mixer at 80° C. to 90° C. for 10 min, and then at 100° C. to 120° C. for 15 min, and then at greater than 120° C. for 5 min.

4. The rigid high-gloss wear-resistant and scratch-resistant flooring according to claim 1, wherein the decorative layer is formed by pressing into a large sheet by a hot press under a high temperature and a high pressure, and then cutting.
